(19) United States
(12) Patent Application Publication
(10) Pub. No.: US 2005/0205354 A1
(43) Pub. Date: Sep. 22, 2005

(54) Dual chamber variable geometry resonator

(75) Inventors: Lakhi N. Goenka, Ann Arbor, MI (US); David J. Moenssen, Canton, MI (US); Christopher E. Shaw, Canton, MI (US); John D. Kostun, Brighton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/804,448

(22) Filed: Mar. 19, 2004

(51) Int. Cl. F01N 1/00; F02K 1/08; F01N 1/16

(52) U.S. Cl. 181/277; 181/271; 181/219

(57) ABSTRACT

The present invention relates to a resonator for attenuating pressure pulsations received through an air passage. A piston-type member is located within a resonator chamber to define first and second volumes. A first port connects the air passage with the first volume, while a second port connects the air passage with the second volume. An actuator is configured to move the piston-type member thereby changing the first and second volumes. By changing the first and second volumes and selectively connecting them to the air passage, the frequency range attenuated by the resonator can be adjusted.

### BACKGROUND

1. Field of the Invention

The present invention generally relates to a resonator for dampening pressure pulsations from an engine.

2. Description of Related Art

Resonators for attenuating pressure pulsation in automotive applications are well known. Internal combustion engines produce undesirable induction noise in the form of pressure pulsations that adversely affect output torque and volumetric efficiency of the engine. The induction noise produced by the engine depends on the engine configuration and engine speed and is caused by a pressure wave that travels from the combustion chamber towards the inlet of the air induction system. This noise may be reduced by producing an attenuation wave traveling in the direction of the combustion chamber 180° out of phase with the noise wave. As such, Helmholtz type resonators have been used to attenuate the noise wave generated from combustion vehicles. In addition, more recently, resonators have been developed that change the volume of the resonator to adjust for varying frequencies of the noise wave as engine speed changes. Previous designs of resonators, however, have not provided a wide enough accommodation to attenuate for various noise frequencies of the engine.

In view of the above, it is apparent that there exists a need for an improved resonator having broader flexibility to attenuate the various noise frequencies of the engine.

### SUMMARY

In satisfying the above need, as well as overcoming the enumerated drawbacks and other limitations of the related art, the present invention provides a resonator for attenuating pressure pulsations received through an air passage. The resonator includes a resonator chamber, first and second openings, first and second valves, a piston-type member, and an actuator or motion control device. The piston-type member is located within the resonator chamber and defines first and second volumes on opposing sides thereof. The first opening connects the air passage with the first volume, while the second opening connects the air passage with the second volume. Located in the first opening is the first valve, which selectively connects the first volume with the air passage. Similarly, the second valve is located in the second opening and selectively connects the second volume with the air passage. The motion control device is configured to move the piston-type member thereby changing the first and second volumes. By changing the first and second volumes and selectively connecting them to the air passage, the frequency range attenuated by the resonator can be adjusted.

While the first valve is open, the motion control device moves the piston-type member to decrease the first volume as the rpm of the engine increases. As the vehicle transmission shifts, the rpm of the engine quickly changes. To accommodate the quick change in rpm, the first valve is closed and the second valve is opened. While the second valve is open, the motion control device is configured to decrease the second volume corresponding to an increase in the rpm of the engine. This process is continued as the car continues to shift during normal operation.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an embodiment of a variable geometry dual volume Helmholtz resonator according to the present invention; and

FIG. 2 is a plot of the active volume of the resonator with respect to the rpm of the engine.

### DETAILED DESCRIPTION

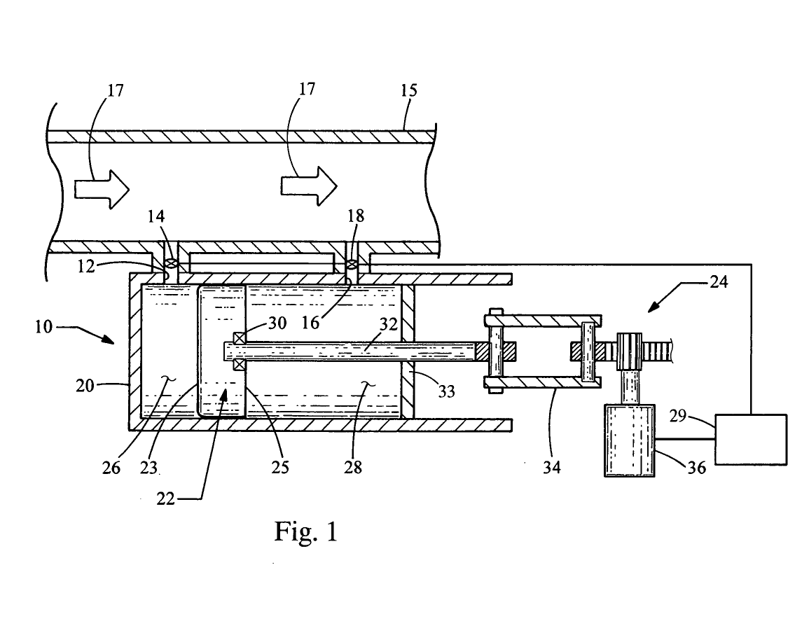

Now referring to FIG. 1, a resonator embodying the principles of the present invention is illustrated therein and designated at 10. The resonator 10 generally includes a first port 12, a first valve 14, a second port 16, a second valve 18, a piston 22, a first resonator volume 26, a second resonator volume 28, and an actuator or motion control device 24.

The intake manifold of an internal combustion engine is coupled to the inlet duct 15 such that air flows, as designated by arrows 17, to the engine for use in the combustion process. As a result of the air induction process, pressure waves are generated that flow back up through the inlet duct 15, producing unwanted noise.

To attenuate this induction noise, the resonator 10 is located so as to be able to generate a wave that is 180° out of phase with the noise wave, and which can be varied in frequency so as to respond to frequency changes in the noise wave and thereby attenuate a greater variety of noise frequencies. To do this, the resonator 10 is in fluid communication with the inlet duct 15. The inlet duct 15 is in fluid communication with the first resonator volume 26 through the first port 12. The first valve 14 is located in the first port 12 and selectively connects the first volume 26 to the inlet duct 15. Similarly, the inlet duct 15 is in fluid communication with the second resonator volume 28 through the second port 16, and the second valve 18 is located in the second port 16 to selectively connect the second resonator volume 28 to the inlet duct 15. The first and second valves 14, 18 are manipulated by a controller 29 and are preferably solenoid valves, although other common valves are contemplated and could readily be used.

As mentioned above, the engine creates a pressure pulsation which flows back through the inlet duct 15 into the first or second resonator volumes 26, 28 of the resonator 10. The resonator attenuates the pressure pulsation by reintroducing the pressure pulsation to the inlet duct 15 with a 180° phase shift, thereby producing a canceling effect.

The resonator 10 includes a housing 20 that cooperate with a first surface 23 of the piston 22 to form the first resonator volume 26. Similarly, a second surface 25 of the piston 22 cooperates with the housing 20 to form a second resonator volume 28 within the housing 20 on an opposing side of piston 22. To allow adjustment of the first and second resonator volumes 26 and 28, the piston 22 can be reciprocated and moved within the resonator 10. The position of the piston 22 is adjusted by the motion control device 24. The controller 29 manipulates the motion control device 24 to drive the piston 22 based on the speed of the engine, thereby adjusting the resonator volume being used to attenuate the pressure pulsation. In one embodiment, the motion control device 24 includes an electric motor 36 that drives a crank shaft 34. The crank shaft 34 is connected to a rod 32 that protrudes into the resonator 10 through an end wall 33 thereof. The rod 32 is attached to the piston 22 at coupling 30 thereby allowing the motor 36 to manipulate the position of the piston 22.

During operation, if the first valve 14 is open thereby connecting the first volume 26 with the inlet duct 15, the piston 22 is translated according to the engine speed to decrease the first volume 26 as the engine speed increases. Alternatively, as the engine speed decreases, the piston 22 is translated to increase the first volume 26. Likewise, if the first valve 14 is closed and the second valve 18 is open connecting the second volume 28 with the inlet duct 15, the piston 22 is moved to decrease the second volume 28 as the engine speed increases and to increase the second volume 28 as the engine speed decreases. The system switches between the first and second volumes to accommodate rapid or dramatic changes in the speed of the engine, such as when the transmission up-shifts or down-shifts.

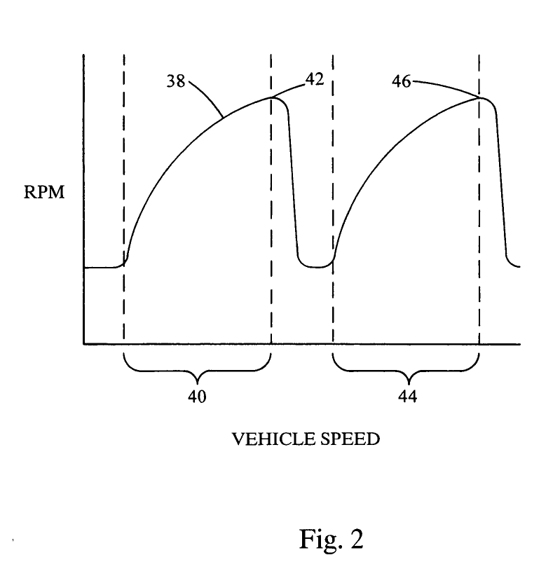

Now referring to FIG. 2, line 38 shows the speed (rpm) of the engine as the speed of the vehicle increases. The frequency of the pressure pulsation increases in relation to the rpm of the engine. During the period indicated by reference numeral 40, the rpm increases along with the frequency of the pressure pulsation. At the time indicated by reference numeral 42, the transmission of the vehicle up-shifts, thereby rapidly decreasing the rpm of the engine. Similarly, the frequency of the pressure pulsation quickly decreases with the rpm of the engine. To accommodate the sudden change in rpm, the resonator 10 is configured to selectively switch from one resonator volume to the other by opening or closing the first and second valves 14, 18.

For example, if at a low engine speed the first valve 14 is open. As the rpm increases during period 40, the motion control device 24 moves piston 22 to decrease the first resonator volume 26 in conjunction with minor changes in the engine rpm. If the engine speed were to undergo a minor slow down, the piston 22 would be moved accordingly to increase the first resonator volume 26 correspondingly. When the engine shifts, indicated by reference numeral 42, a dramatic engine speed change occurs. To accommodate this rapid change, the first valve 14 is closed and the second valve 18 is opened, thereby quickly coupling the inlet duct 15 a larger volume and thereby accommodating the lower engine rpm. During period 44, the motion control device 24 again moves the piston 22 to reduce the second resonator volume 28 in accordance with the engine rpm until the next transmission shift occurs, as indicated by reference numeral 46. At the next transmission shift, the second valve 18 may be closed and the first valve 14 opened, again quickly switching to the first resonator volume 26 that is appropriately sized for the lower engine rpm. The process may be continued as the transmission upshifts and downshifts during the normal operation of the vehicle.

Although the system here is shown with two ports 12, 16 and one movable piston 22, it is also envisioned that multiple openings and multiple members may be used in conjunction with each other to simultaneously address multiple frequency ranges. Further, the valves may be independently controllable to attenuate multiple frequency pressure pulsations in certain ranges.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A resonator for attenuating pressure pulsations received through an air passage, the resonator comprising:
a housing defining a resonator chamber;
a movable member located within the resonator chamber and cooperating with the housing to divide the resonator chamber into first and second volumes;
a first port coupling the first volume with the air passage;
a second port coupling the second volume with the air passage;
a first valve located within the first port to selectively connect the first volume with the air passage;
a second valve located within the second port to selectively connect the second volume with the air passage; and
an actuator coupled to the movable member and configured to move the movable member thereby changing the first and second volume.

2. The resonator according to claim 1, wherein the actuator is configured to move the movable member thereby decreasing the first volume as the rpm of the engine increases and while the first valve is open.

3. The resonator according to claim 1, wherein the second valve is configured to open corresponding to a change in the rpm of the engine.

4. The resonator according to claim 3, wherein the first valve is configured to close corresponding to a change in the rpm of the engine.

5. The resonator according to claim 3, wherein the actuator is configured to move the member thereby decreasing the second volume corresponding to an increase in the rpm of the engine when the second valve is open.

6. The resonator according to claim 1, wherein the first valve is a solenoid.

7. The resonator according to claim 6, wherein the second valve is a solenoid.

8. The resonator according to claim 1, wherein the actuator is an electric motor.

9. The system according to claim 1, wherein the first and second valves are independently controllable to attenuate multiple frequencies.

10. A resonator for attenuating pressure pulsations received through an air passage, the resonator comprising:
a housing defining a resonator chamber;
a movable member located within the resonator chamber and cooperating with the housing to divide the resonator chamber into first and second volumes;
a first port coupling the first volume with the air passage;
a second port coupling the second volume with the air passage;
a first valve located within the first port to selectively connect the first volume with the air passage;
a second valve located within the second port to selectively connect the second volume with the air passage;
an actuator coupled to the movable member and configured to move the movable member thereby changing the first and second volume; and
a controller in communication with the first valve, the second valve, and the actuator, the controller being configured to selectively actuate the first and second valve and manipulate the actuator to position the movable member.

11. The resonator according to claim 10, wherein the controller is configured to drive the actuator moving the movable member thereby decreasing the first volume as the rpm of the engine increases and while the first valve is open.

12. The resonator according to claim 10, wherein the controller is configured to open the second valve corresponding to the shift in the rpm of the engine.

13. The resonator according to claim 12, wherein the controller is configured to close the first valve corresponding to the shift in the rpm of the engine.

14. The resonator according to claim 12, wherein the controller is configured to drive the actuator moving the movable member thereby decreasing the second volume corresponding to an increase in the rpm of the engine when the second valve is open.

15. The resonator according to claim 10, wherein the first valve is a solenoid.

16. The resonator according to claim 15, wherein the second valve is a solenoid.

17. The resonator according to claim 10, wherein the actuator is an electric motor.

18. The system according to claim 10, wherein the controller is configured to independently control the first and second valves to attenuate multiple frequencies.

19. A resonator for attenuating pressure pulsations received through an air passage, the resonator comprising:
a first adjustable volume defined in part by a housing;
a second adjustable volume defined in part by a housing;
a first port communicating the first volume with the air passage;
a second port communicating the second volume with the air passage;
a first valve for selectively opening and closing the first port;
a second valve for selectively opening and closing the second port;
the first and second volumes each being adjustable by an actuator; and
wherein when the first valve is open, the first volume is decreased engine rpm increases and the first volume is increased as the engine rpm is decreased.

20. The resonator according to claim 19, wherein when the first valve is closed the second valve is open.

21. The resonator according to claim 19, wherein first and second volumes are adjustable by a common actuator.

22. The resonator according to claim 19, wherein the first valve is a solenoid.

23. The resonator according to claim 22, wherein the second valve is a solenoid.

24. The resonator according to claim 19, wherein only one of the first and second valves is open at a time.

25. The system according to claim 19, wherein the first and second valves are independently controllable.
